(19) United States
(12) Patent Application Publication
(10) Pub. No.: US 2005/0159158 A1
(43) Pub. Date: Jul. 21, 2005

(54) Method and system for providing mobile handoff between hybrid networks

(76) Inventors: Kohli Pardeep, Piano, TX (US); Atam Mahbubul, Dallas, TX (US)

Correspondence Address: HAYNES AND BOONE, LLP, 901 MAIN STREET, SUITE 3100, DALLAS, TX, 75202, US

(21) Appl. No.: 10/503,753

(22) PCT Filed: Feb. 26, 2003
(86) PCT No.: PCT/US03/06338

Related U.S. Application Data
(60) Provisional application No. 60/360,348, filed on Feb. 27, 2002.

(51) Int. Cl. H04Q 7/20

(52) U.S. Cl. 455/436; 455/426.1; 455/437

(57) ABSTRACT

A method and system is disclosed for providing a handoff solution to a mobile moving between two hybrid networks by using Core network technology protocols, and having both hybrid networks composed of CDMA RAN and GSM CN. The method uses a Hybrid Mobile Switch Center (HMSC) and a predetermined protocol to operate messages between the first and second wireless network in order to facilitate the call handoff from the first to the second RAN.

### CROSS REFERENCE TO RELATED APPLICATIONS

This application is a National Phase of International Patent Cooperation Treaty Application No. PCT/US2003/006338, filed Feb. 26, 2003, which claims priority from U.S. Provisional Patent Application Ser. No. 60/360,348, filed on Feb. 27, 2002, entitled Method and System for Providing Mobile Handoff Between Hybrid Networks, which is hereby incorporated by reference in its entirety.

### BACKGROUND OF THE INVENTION

The present invention relates generally to voice and data communications, and more particularly, to a wireless system and method for providing call handoff service to a wireless mobile while it travels between one hybrid wireless network to another hybrid wireless network.

A typical wireless network is composed of two sub-networks: a Radio Access Network (RAN) which handles radio related issues such as assigning radio resources to a mobile terminal (or “mobile” in short) upon request for services, and a Core Network (CN) which links the mobile user to wireline networks. Current specifications of wireless networks require that the RAN and CN have the same wireless technology in order to provide wireless services. These networks may be referred to as “homogeneous networks.” For instance, a GSM mobile will only operate in a wireless network which its RAN and CN are both GSM wireless technology based.

FIG. 1 illustrates a GSM wireless network 100 composed of a GSM RAN 102 and a GSM CN 104. The GSM RAN 102 includes a GSM Mobile Station (MS) 106 that 110. The GSM BSS 108 includes a GSM Base Transceiver Station (BTS) 110 and GSM Base Station Controller (BSC) 112.

The GSM Core Network (CN) 104 includes a GSM Mobile Switching Center (MSC) 120 that is connected to the GSM BSC 112 as well as a GSM Gateway MSC (GMSC) 122 by using SS7 ISUP communications 124. The GSM GMSC 122 is also connected to the Public Switched Telephone Network (PSTN) 126 by using SS7 ISUP communications 124. In this figure, a telephone 128 is shown to be connected to the PSTN as an illustration of a calling/called party. In addition, a Serving General Packet Radio Service Node (GPRS) (SGSN) 130 is shown to also be connected to the GSM BSC 112. Moreover, a GSM Short Message Service Center (SMS-C) 132, a GSM Home Location Register (HLR) 134 and a GSM Authentication Center (AuC) 136 are all shown to be connected the GSM MSC 120 and the SGSN 130. Further, a GSM Service Control Point (SCP) 138 connects a GSM Billing System 140 to the GSM MSC 120 and the GSM HLR 134. The connection from the GSM Billing System 140 and the GSM MSC 120 utilizes IP. Additionally, a Packet Data Network (PDN) 142 is shown connected to the GSM CN 104 through a Gateway GPRS Node (GGSN) 144 utilizing IP communications.

A disadvantage of this configuration is that, given many wireless technologies that exist today and considering new ones being defined for the future, this is a serious limitation in the wireless service provision to deal with a situation in which a mobile compatible with one wireless technology moves into a wireless network of different technology. This prevents the mobile from getting services and limits the mobile's geographical service area to networks that support a specific wireless technology. The same limitation applies to wireless networks that are CDMA wireless technology based.

FIG. 2 illustrates such a CDMA2000 based network 200. The CDMA2000 RAN 201 includes a CDMA2000 MS 202 connected to a CDMA2000 BSS 204 through a CDMA2000 BTS 206. The CDMA2000 BTS 206 is in turn connected to a CDMA2000 BSC 208, which connects to a Packet Control Function (PCF) 210.

A CDMA2000 CN 212 connects to the CDMA2000 RAN 201 by the CDMA2000 BSC 208 connecting to a CDMA200 MSC 214. The CDMA2000 MSC 214 is connected to an IS-41 SMS-C 216, an IS-41 HLR 218, an IS-41 AuC 220 and an IS-41 SCP 222. The IS-41 SCP 222 in turn is also connected to the IS-41 HLR 218 and a Store and Forward Service 224, which in turn is connected to an IS-41 Billing System 226. In addition, a Packet Data Serving Node (PDSN) 228 is connected to the PCF 210 of the CDMA2000 RAN 200 and a PDN 230. Moreover, the CDMA2000 MSC 214 connects the CDMA2000 CN 212 to the PSTN 232 and a phone 234.

A hybrid wireless network is a wireless network composed of a RAN and a CN of different technologies linked. This network architecture presents a large advantage in deployment speed and cost reduction over the traditional homogeneous wireless networks discussed previously. Such a network enables a mobile terminal in one of the RANs and certain network entities in the CN to exchange message contents without being obstructed by the differences in the technologies involved (e.g., message encoding and decoding schemes).

However, there is a lack of handoff solution for this problem so far for dealing with a hybrid network (or a composite network) wherein the CN and its RAN based on two different technologies. Without this “dual” handoff ability, the dual mode mobile cannot receive service when moving between CDMA and GSM networks, and the service connection will be dropped when the mobile enters a new RAN having a technology different from the one it just left.

Thus, what is needed is a solution that would perform a handoff from one hybrid network to another hybrid network using the GSM Core Network protocols and having CDMA RAN technology in both hybrid networks.

### SUMMARY OF THE INVENTION

A method and system is disclosed for providing a handoff solution for a mobile moving between two hybrid networks by using Core network technology protocols. The method uses a Hybrid Mobile Switch Center (HMSC) to operate message communications between the first and second hybrid wireless network in order to facilitate the call handoff from the first to the second RAN.

In one example of the present disclosure a method and system is disclosed for performing handoff operations for a mobile terminal moving between the two hybrid networks.

### BRIEF DESCRIPTION OF THE DRAWINGS

FIG. 1 illustrates a GSM based wireless network for providing services to a mobile user.

FIG. 2 illustrates a CDMA based wireless network for providing services to a mobile user.

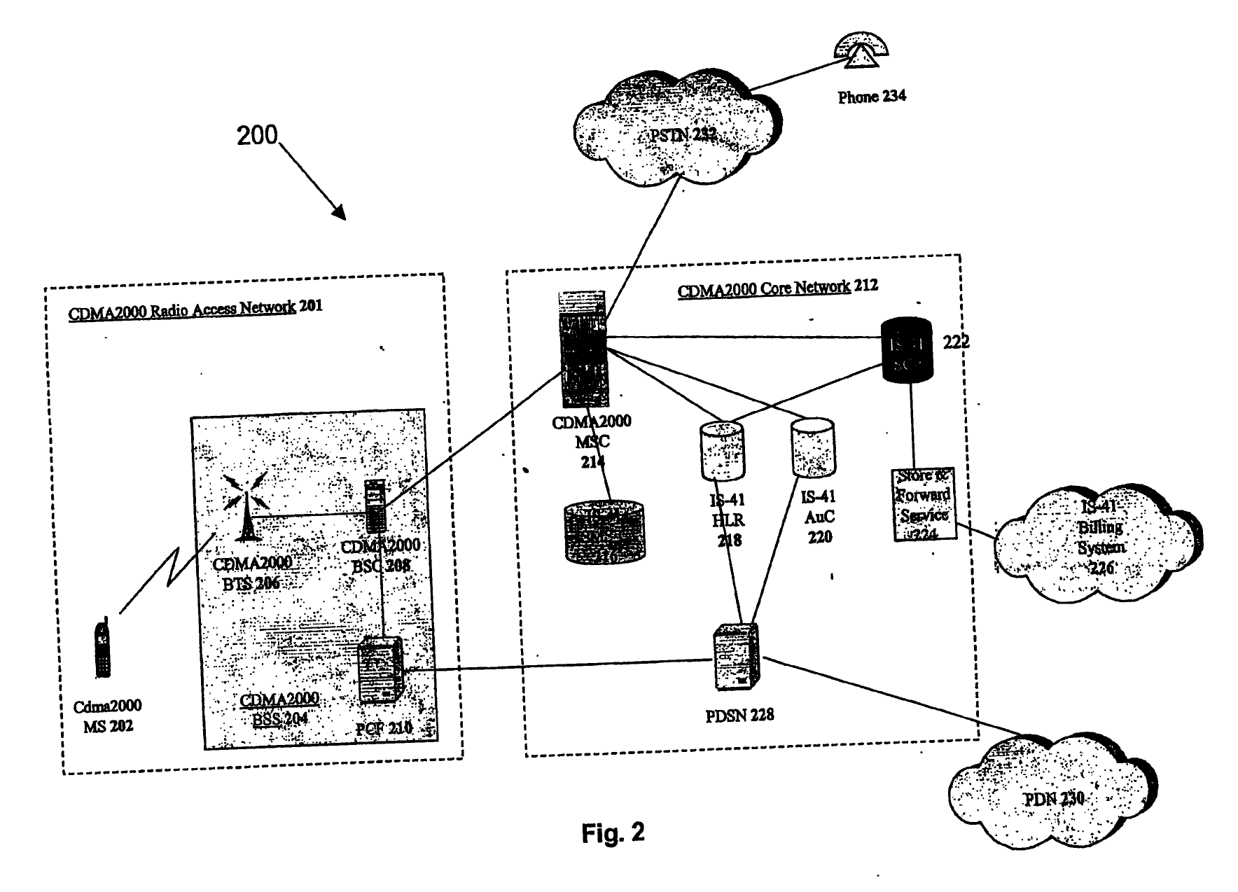

FIG. 3 illustrates a hybrid wireless network with a Hybrid Mobile Switching Center and utilizing the CDMA wireless technology in its RAN and GSM wireless technology in its CN according to one example of the present disclosure.

FIG. 4 illustrates a network of two different CDMA RANs serviced by two different HMSCs according to another example of the present disclosure.

FIG. 5 illustrates a handoff message flow between two Hybrid MSC with CDMA RANs and GSM Core Network.

### DESCRIPTION OF THE PREFERRED EMBODIMENT

For the purposes of the present disclosure, various acronyms are used, and the definitions of which are listed below:
ANSI-41 American National Standards Institute—Cellular Radio Telecommunications Intersystem Operations.
AuC Authentication Centre—a permanent database server used in mobile systems to identify a subscriber and to contain subscriber data related to features and services.
BSC Base Station Centre
BSS Base Station System
BTS Base station Transceiver System
CN Core Network
GGSN Gateway GPRS Support Node
GMSC Gateway Mobile Switching Centre—a means to route a mobile station call to the MSC containing the called party's Home Location Register.
GPRS General Packet Radio Service—a service designed for GSM digital cellular networks to support transmission of intermittent and bursty data transfers as well as occasional transmission of large volumes of data. The most common application of GPRS is expected to be Internet/intranet access.
GSM Global System for Mobile communications
HLR Home Location Register—a permanent SS7 database used in cellular networks.
IP Internet Protocol
IS41 Wireless Network conforming to the IS41 standard
ISDN Integrated Services Digital Network
ISUP ISDN User Part (of SS7)
MSC Mobile Switching Centre
PDN Public Data Network—a public network for the transmission of data, particularly a network compatible with X.25 protocol.
PCF Packet Carrying Function—formerly called an InterWorking Function or IWF
PSTN Public Switch Telephone Network
RAN Radio Access Network
SCP Signal Control Point—a remote database within a System Signaling 7 network to supply translation and routing data needed to deliver advanced network services.
SMS Short Message Service—short text messages exchanged between mobile telephones and other networks.
SMS-C Short Message Service Centre—the entity that stores and forwards Short Message Service (“SMS”) messages.
SS7 Signaling System No.7
T1 Digital communication line that uses time division multiplexing with an overall transmission rate of 1.544 million bits per second.
TCP/IP Transmission Control Protocol/Internet Protocol

The present disclosure provides several examples below, and it is understood that the examples are not necessarily limitations to the present invention, but are used to describe embodiments of the method and system of the present invention.

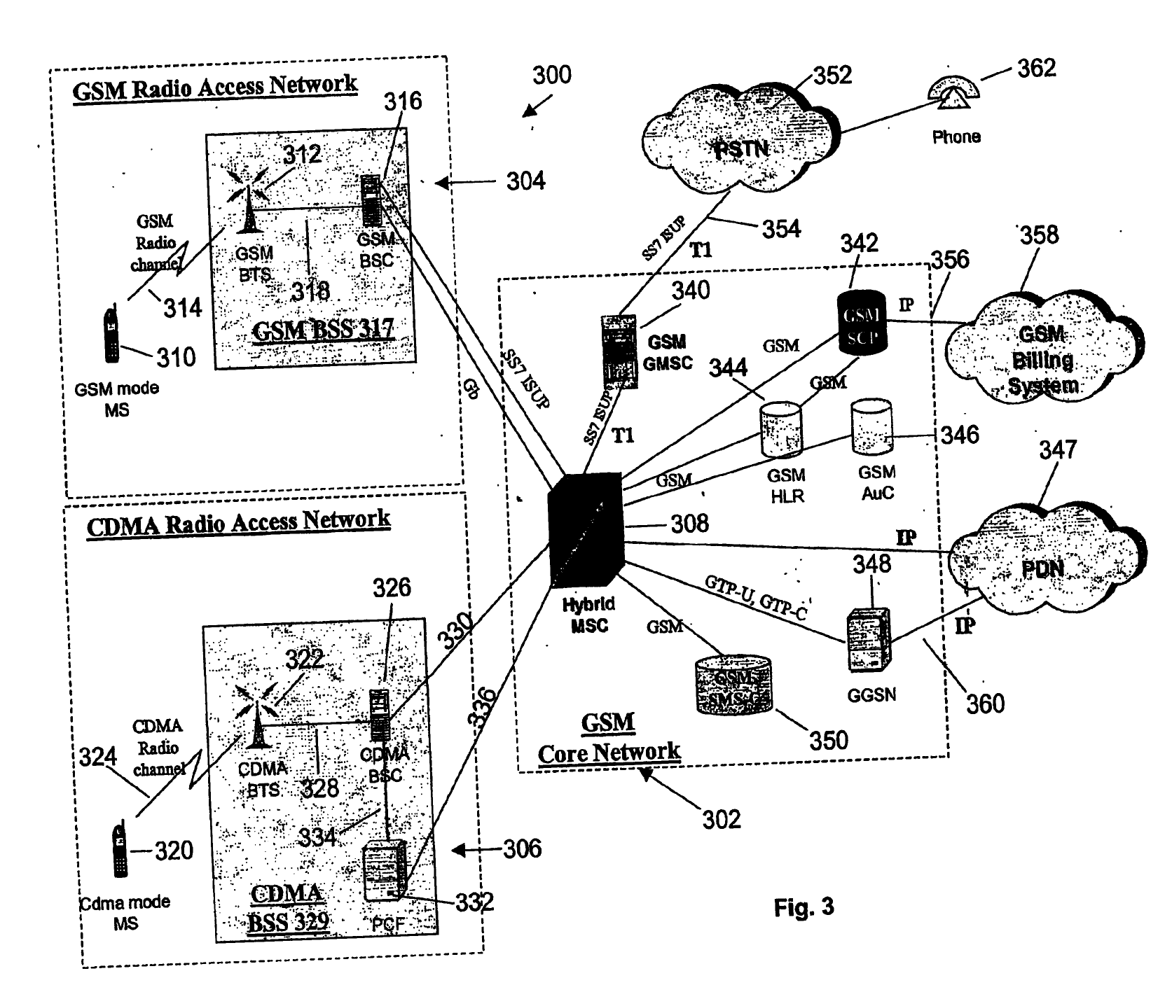

FIG. 3 illustrates a hybrid wireless network 300 including a GSM CN 302, which may be in communication with a GSM RAN 304 and/or a CDMA RAN 306. The RAN 304 and 306 communicate with the CN 302 through a Hybrid Mobile Switching Center (HMSC) 308. A detailed description thereof can be found in co-pending patent application Ser. No. 60/345,050, which was filed on Nov. 9, 2001 and entitled “Method and System for Providing Wireless Services in a Composite Wireless Network Comprising at Least One Access Network and One Core Network of Different Technologies.” In this example, the HMSC 308 has a centralized call control model for voice and packet data calls. This module allows the HMSC 308 to handle and keep track of all calls for a given mobile phone. In contrast, in a traditional GSM MSC or a CDMA MSC the call control for data and voice are located in different network entities. In this example embodiment, setting-up and controlling a voice or a data call for a mobile user is performed at the HMSC 308.

The example network architecture shown in FIG. 3 illustrates a hybrid network utilizing certain aspects of the present invention. The illustrative network provides both voice and packet data services to mobile stations in either of the two networks. For instance, in the GSM RAN 304, a GSM mobile unit 310 communicates with a GSM BTS 312 over a GSM radio link 314. The GSM BTS 312 typically communicates with a GSM BSC 316 using a wired link 318. The BTS 312 and BSC 316 comprise a base station system or BSS 317. In the illustrative embodiments, the HMSC 308 communicates with the GSM BSC 316 over a voice link using an SS7 ISUP protocol and over a data link using a Gb protocol.

Similarly, in the CDMA RAN 306, a CDMA 2000 mobile phone 320 communicates with a CDMA BTS 322 over a CDMA radio link 324. The CDMA BTS 322 typically communicates with a CDMA BSC 326 using a proprietary wired link 328. Typically, for voice communications, the CDMA BSC 326 communicates with the HMSC 308 over a link 330 using a variety of protocols, including A1, A2, A5, A8, and A9. The CDMA BSC 326 transfers data to a PCF 332 over a link 334 using A8 and A9 protocols. Thus, data is usually sent by the PCF 332 to the HMSC 308 over a link 336 using the A10 and A11 protocols.

If the core network is a GSM network, as in the illustrative network 300, the HMSC 308 communicates with the other GSM network components in much the same way a typical MSC would communicate with the GSM network components. For instance, the HMSC 308 may establish links with a GMSC 340, a SCP 342, an HLR 344, a AuC 346, a PDN 347, a GGSN 348, and/or a SMS-C 350. Similarly, the GMSC 340 may communicate with a PSTN 352 through a T1 link 354 using a SS7 ISUP protocol. The SCP 342 may establish a link 356 with a billing system 358, and the GGSN 348 may establish a link 360 with the PDN 347, where the links 356 and 360 use an IP protocol. Thus, for each connection, FIG. 3 illustrates an example link and the corresponding communication protocol used to allow communication between typical network entities. As those skilled in the art would recognize, similar communication links may be established if the CN 302 were a CDMA network.

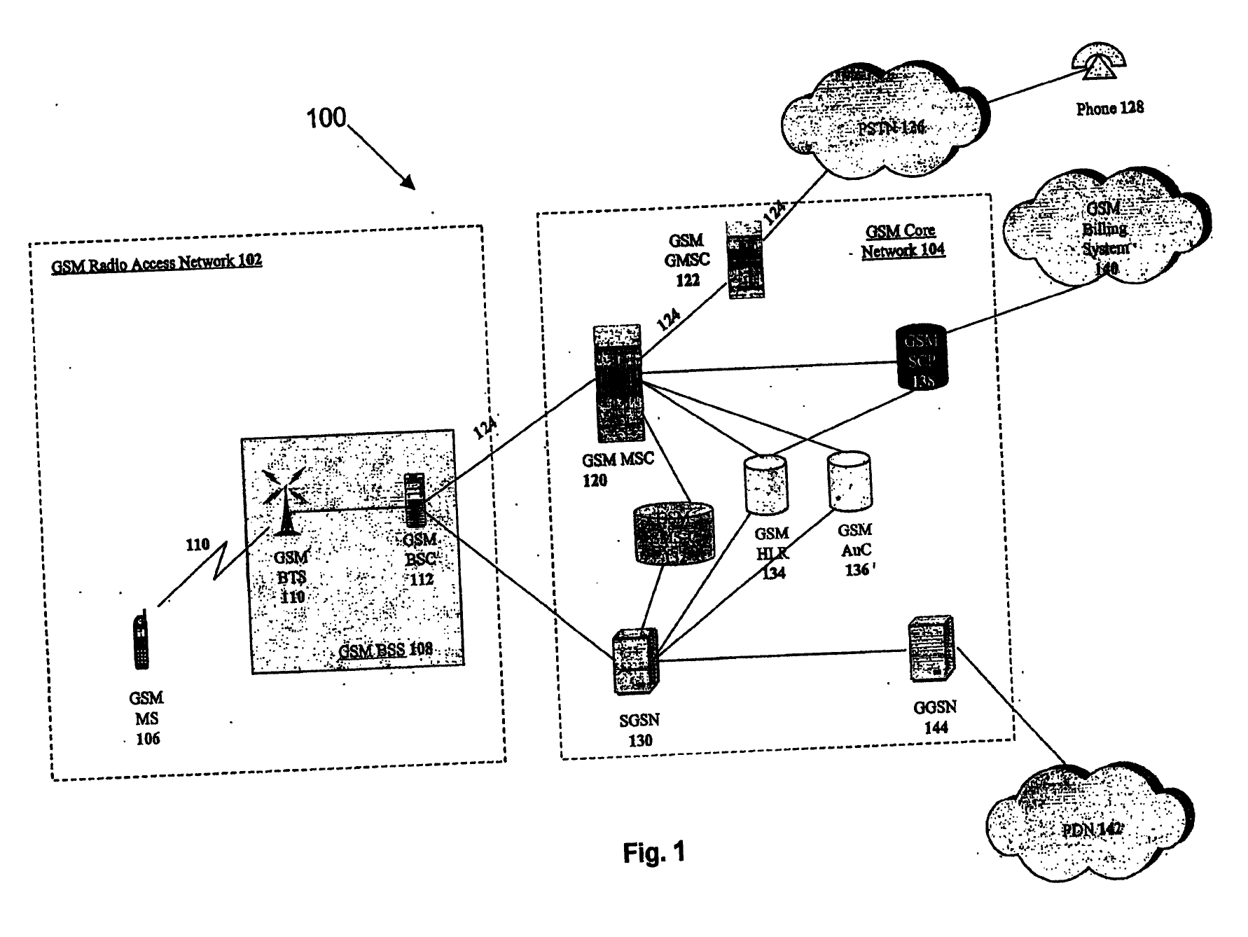

Thus, for calls established with the GSM mobile 310, the HMSC 308 acts like a GSM MSC 110 as depicted in FIG. 1. For calls established with the CMDA2000 mobile 320, the HMSC 308 links the CDMA RAN 306 to the GSM CN 302 by translating and mapping CDMA RAN messages initiated in the RAN 304 into GSM CN messages sent to the CN 302, and GSM messages initiated by the CN 302 into CDMA messages sent to the RAN 306.

The HMSC 308 can support voice and packet data call services from mobiles in any type of RAN to any other type of network. For instance the mobile 310 in the GSM RAN 304 can make a call to another mobile (not shown) operating in the CDMA RAN 306, a telephone 362 connected to the PSTN 352, or an entity as part of the PDN 347 and other networks that are not illustrated nor discussed in this disclosure for reasons of simplicity and clarity. The HMSC 308 is shown in communication with two RANs of different technologies, however as would be clear to one skilled in the art, the present invention also applies in situations where the HMSC 308 is in communication with one or more RANs of same technology.

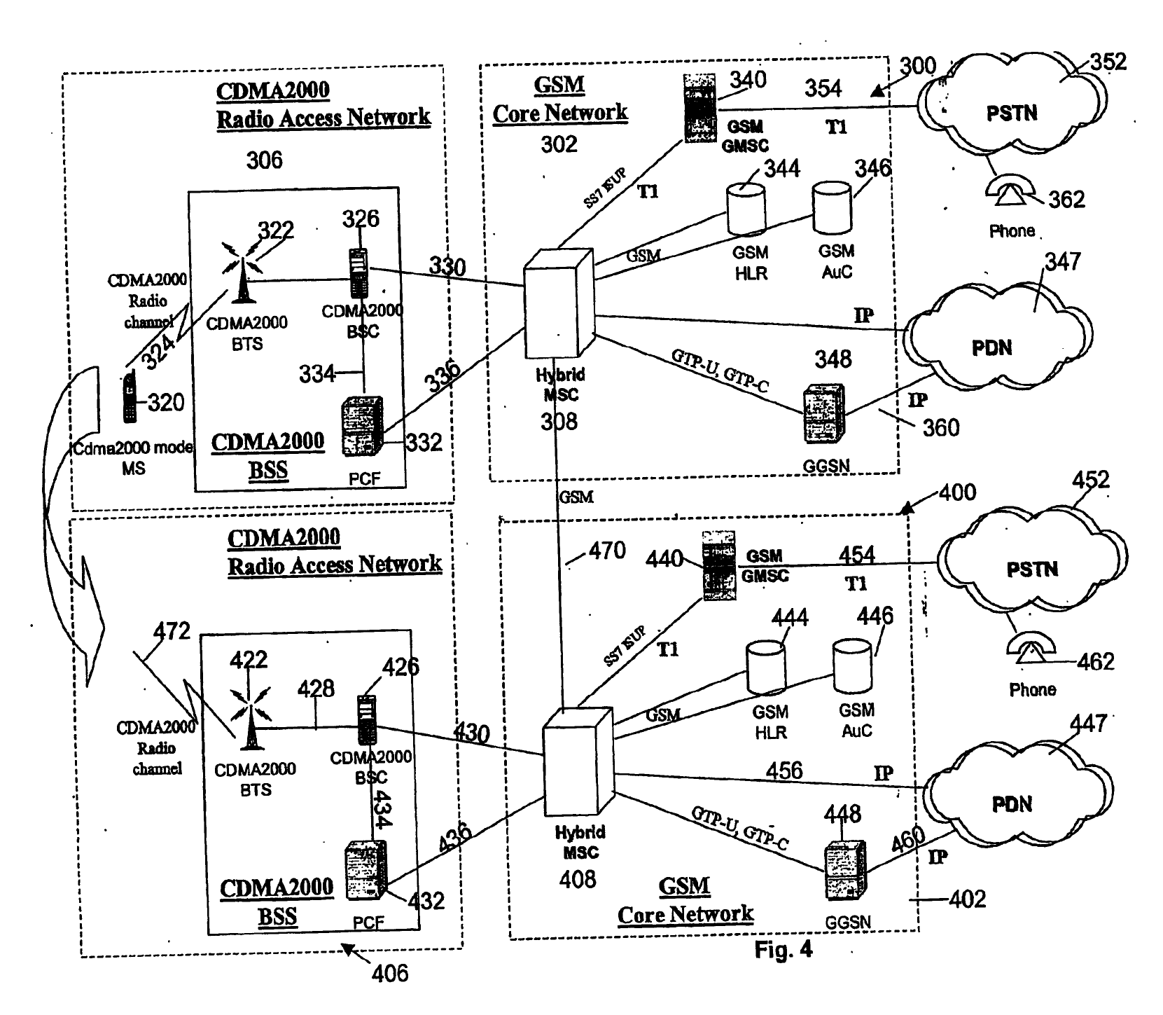

FIG. 4 illustrates two exemplary networks: the network 300 described previously in reference to FIG. 3 and a network 400. The network 400 is an example another a hybrid network similar to the hybrid network 300. For simplicity and illustrative purposes, it will be assumed that the network 300 and 400 are each in communication with two different CDMA RANs. The CDMA RAN 306 is in communication with the GSM CN 302. Similarly, a CDMA RAN 406 is in communication with a GSM core network or CN 402. A CDMA BTS 422 communicates over CDMA radio links with CDMA and dual mode phones that may be within the radio range. The CDMA BTS 422 typically communicates with a CDMA BSC 426 using a proprietary wired link 428. Typically, for voice communications, the CDMA BSC 426 communicates with a HMSC 408 over a link 430 using a variety of protocols, including A1, A2, A5, A8, and A9. The CDMA BSC 426 transfers data to a PCF 432 over a link 434 using A8 and A9 protocols. Thus, data is usually sent by the PCF 432 to the HMSC 408 over a link 436 using the A10 and A11 protocols.

If the core network is a GSM network, as in the illustrative network 400, the HMSC 408 communicates with the other GSM network components in much the same way a typical MSC would communicate with the GSM network components. For instance, the HMSC 408 may establish links with a GMSC 440, an HLR 444, a AuC 446, a PDN 447, and a GGSN 448. Similarly, the GMSC 440 may communicate with a PSTN 452 through a T1 link 454 using a SS7 ISUP protocol. The GGSN 448 may establish a link 460 with the PDN 447, where the links 456 and 460 use an IP protocol. Thus, for each connection, FIG. 4 illustrates an example link and the corresponding communication protocol used to allow communication between typical network entities. As those skilled in the art would recognize, similar communication links may be established if the CN 402 were a CDMA network.

Thus, for calls established from the CDMA RAN 404, the HMSC 408 links the CDMA RAN 406 to the GSM CN 402 by translating and mapping CDMA RAN messages initiated in the RAN 404 into GSM CN messages sent to the CN 402, and GSM messages initiated by the CN 402 into CDMA messages sent to the RAN 406.

The HMSC 408 can support voice and packet data call services from mobiles in any type of RAN to any other type of network. For instance a mobile in the GSM RAN 404 can make a call to another mobile operating in the CDMA RAN 306, a telephone 462 connected to the PSTN 452, or an entity as part of the PDN 447 and other networks that are not illustrated nor discussed in this disclosure for reasons of simplicity and clarity.

As illustrated, the source HMSC 308 is in communication with the HMSC 408 over a GSM link 470, however as would be clear to one skilled in the art, the present invention also applies in situations where the HMSC 408 is in communication with one or more core networks of different technology.

By way of example, assume that the dual mode MS 320 is traveling away from the BTS 322 of the network 300 and towards BTS 422 of network 400. As the MS 320 travels away from the BTS 322, the RF link 324 between the MS 322 and the BTS 322 will eventually become too weak to support communications there between and will eventually disconnect, resulting in the call in progress being dropped. To avoid this problem, as the mobile unit nears the BTS 422, a new communications path will be established. The communications path will comprise an RF link 472 between the MS 320 and the BTS 422. At this point, the mobile unit is directed to end communication with the BTS 322 and begin communication with the BTS 422. The process of a mobile unit's terminating communication with one BTS and commencing communication with another BTS is commonly referred to as “handoff.”

In a CDMA cellular communication system, each BTS transmits its own unique pilot carrier signal, or “pilot signal,” on a pilot channel. The pilot signal is an umnodulated, direct sequence, spread spectrum signal continuously transmitted by each BTS using a common pseudo-random noise (PN) spreading code. The pilot signal allows the mobile units to obtain initial system synchronization, e.g., timing, in addition to providing a phase reference for coherent demodulation and a reference for signal strength for comparisons between base stations for handoff determination.

Because mobile units typically move between BTSs, mobile units continually scan for (e.g., measure the strength of) pilots in a search window around the spreading (or PN) sequence phase offsets where neighbor base stations are known to be transmitting. A BSC obviously knows of neighboring BTSs. The BSC helps the mobile unit identify the pilots from neighboring BTSs by sending the mobile unit the PNs for the neighboring BTSs. In other words, the BTS tells the mobile where to look for the pilots from neighboring BTS.

Because the MS 320 is moving from the BTS 322 which is controlled by the hybrid MSC 308 or “HMSC 308” to another hybrid MSC or “HMSC 408,” the two HMSCs also establish communication links regarding the handoff. In the example of FIG. 4, the HMSC 308 is known as the “source HMSC” and the HMSC 408 is known as the “target HMSC.”

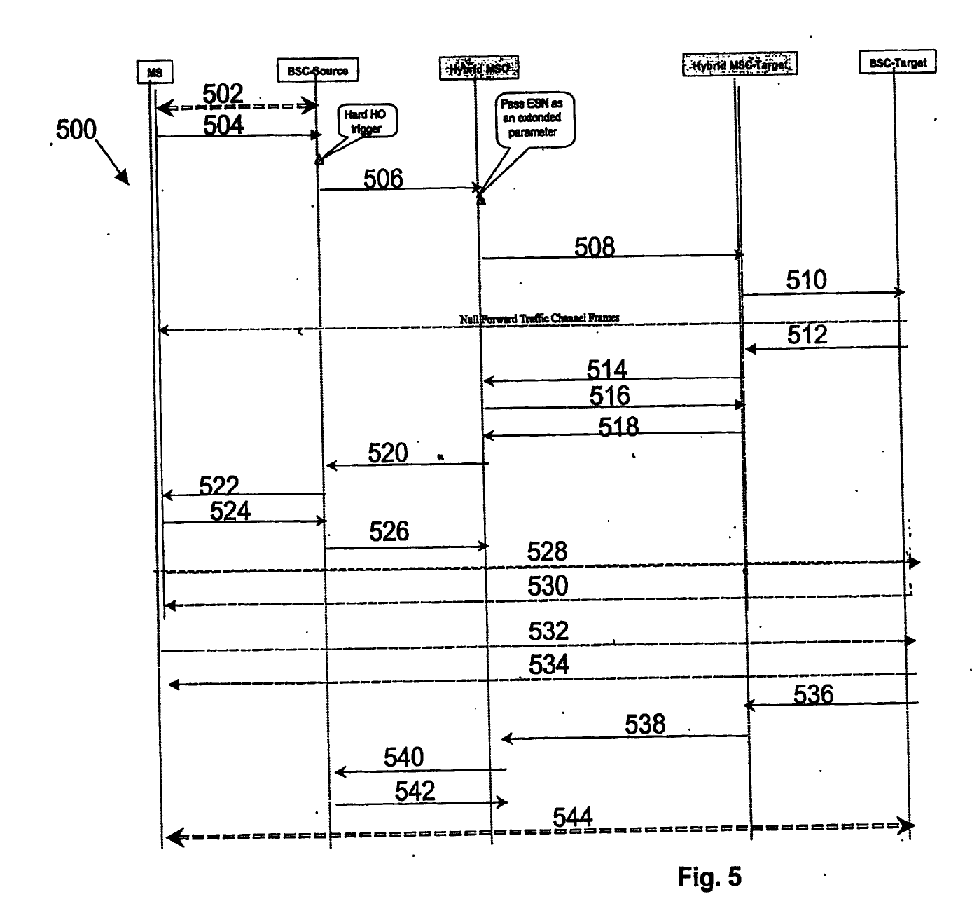

In order to illustrate one embodiment of the present invention, a voice call will be used as an example of the process. FIG. 5 illustrates an example messaging call flow 500 for a handoff procedure. In step 502, the MS 320 is operating according to CDMA protocol and the voice call is active, i.e. forward and reverse traffic channels are allocated. When the MS 320 approaches the boundary of the cell, it sees stronger beacon signal from cells across the border (i.e., from the BTS 422 of FIG. 4). The MS 320 then sends signal strength message 504, such as a PSMM message to BSC 326 to notify the new beacon signal. The message may include PN phase and strength of all pilots in the active and candidate list.

The BSC 326 may trigger hard handoff (“HO”) process when it finds that the pilot just reported by MS 320 along with all other pilots in the active set list is of the type of boarder cell. In this case, the MS 320 detects a new pilot signal from the target BSC 426 within the target HMSC 408 domain. This pilot signal is usually in the form of a beacon signal to induce the hard HO triggering on the same CDMA frequency of the existing cell and the same PN offset as the actual target pilot signal.

After triggering, the BSC 326 sends message 506 to the HMSC 308 to initiate hard HO process. The message could be a IOS: HO_Required message, which includes a list of candidate target cell ID, information about service option and pilot strength measurements that allows HMSC to determine the optimal target cell. The HMSC 308 makes the decision based on information it receives from BSC 326, its own internal information or a combination of both.

Upon receiving a HO_Required message from source BSC 326, the source HMSC 308 identifies the target BSC and its associated target MSC. The source HMSC 308 then allocates an inter-MSC trunk circuit 470 between it and the target HMSC 408 to be used for call setup. The source HMSC 308 then sends a prepare handover request message 508 (e.g., MAP_Prepare_Handover_Req) to the target HMSC 408, which initiates the hard handoff process. The message may include the target cell ID so that the target HMSC 408 can allocate resources. In CDMA to CDMA handoffs, the target BS requires the IMSI and ESN parameters for calculating Public long code. Therefore, in some embodiments, an extension to this message may be used to carry the ESN information. This parameter is conditional and is used for 1×GSM (CDMA) to 1×GSM (CDMA) handover while MS is operating in CDMA mode. The 1× Service Option may be mapped into corresponding GSM vocoding: EVRC⇄Half Rate; 13k⇄Full Rate. At the target 1×GSM MSC, if the target BSC is 1×BSC, the service option is mapped back, i.e. FULL Rate⇄13k; Half Rate⇄EVRC.

The target HMSC 408 coordinates the hard hand off by sending a message 510 to the target BSC 426, such as an IOS: HO_Request. The target HMSC 408 may construct this message with the information received form source HMSC 308 through MAP messages and its internal information for the required fields. The HO_Request message, for instance, may be sent as an SCCP-CR, soliciting that a new SCCP connection be established for subsequent HO messages. This message may be used to allocate terrestrial and radio resources at the target BSC 426.

The target BSC 426 upon receiving the HO-Request message 510, may allocate necessary resources and then prepares for the radio channel switchover by sending a signal, such as a null traffic (e.g., Null FTCH Frames) to the MS 320.

Upon successful allocation of the resources required to service the HO call, the target BSC 426 may send an acknowledgement message 512 (e.g. IOS: HO_Request_Ack) to the target HMSC 408 to inform it of the successful resource allocation. The target HMSC 408 may then respond to the source HMSC 308 with a message 514 (e.g., MAP_Prepare_Handover_rsp) indicating the successful completion of the handoff preparation.

Upon receiving the acknowledgement 514 from target HMSC 408, the source HMSC 308 may set up a traffic channel with the target HMSC 408. This may be performed by an initial message 516, such as an ISUP: IAM message. The address information used in IAM message may be the HO number. The target HMSC 408 may then respond with an acknowledgment message 518, such as a ISUP: ACM message.

The source HMSC 308 may then send a message 520 (e.g., IOS: HO_Command) informing the source BSC 326 to direct the MS 320 to switch to new CDMA channel associated with the target cell. This message may include an HO specific and CDMA parameter information received earlier in HO_Request_Ack message 512.

The base station 326 may then direct the mobile station 320 to perform a CDMA- to-CDMA hard handoff by sending a message 522, such as a Extended Handoff Direction Message (IS2000: EHDM/GHDM). The BSC 326 may set the HARD_INCLUDED field to 1 and may send BAND_CLASS, CDMA_FREQ, CODE_CHANNEL_INDEX parameter for the mobile to setup FTCH.

In response, the MS 320 may send an acknowledgement message 524 (e.g., MS_ack_order) back after a successful acquisition of the target cell. A status message 526, such as a IOS: HO_Commenced message may be sent from the source BSC 326 to the HMSC 308 to indicate that the mobile is not expected to return to the source BSC 326. As directed in Extended Handoff Direction Message 522, the MS 320 switches to the new CDMA channel and begins sending reverse traffic channel preamble frames in step 528. The communication between MS and source BSC 326 terminates. Once target BSC 426 receives preamble frames, it may send an acknowledgement message 530 (e.g., BS_Ack_Order) to the MS 320.

The MS 320 may send a handoff completion message 532 (e.g., HO_Completion_Message) to the target BSC 426 to indicate that the handoff from the source BSC 326 was successful. The target BSC 426 may acknowledge the message 532 by sending an acknowledgement message 534 (e.g., BS_Ack_Order). The target BSC 426 may send a message 536, such as a IOS: HO_Complete, to the target HMSC 408 to indicate that the MS 320 has successfully performed the handoff. Upon receiving the message 536, the target HMSC 408 may send a message 538 (e.g., ISUP: ANM ) to the source HMSC 308, thereby connecting a through traffic channel between the source HMSC 308 and the target HMSC 408.

After the successful completion of the handoff, the source HMSC 308 may send a clear message 540 (e.g., IOS: Clear_Command) to the source BSC 408 to free up terrestrial and radio resources. After successful resource de-allocation, the source BSC 326 may send a response 542 (such as a Clear_Complete message to the source HMSC 308). In step 544, the call then continues between the target BSC 426 and the MS 320.

Thus, at the end of the handoff procedure, the dual mode mobile stays in CDMA mode and continues the voice communication.

During the above process 500, message parameters may be mapped between the CDMA commands of the RAN and the GSM commands of the core networks. For instance, the message “Handoff Required”, (a BSMAP message) is sent from the BS to the MSC to indicate that for a given MS which already has a dedicated radio resource assigned, a handoff is required for the reason given by the cause element. The table below shows more details about the message.

| Handoff Required IE | Section | Type | 1xGSM | Comments |
|---|---|---|---|---|
| Message Type | 6.2.2.4 | M | Y | |
| Cause | 6.2.2.19 | M | Y | |
| Cell Identifier List (Target) | 6.2.2.21 | M | Y | |
| Classmark Information Type 2 | 6.2.2.15 | O/R | Y | |
| Response Request | 6.2.2.35 | O/R | Y | |
| Encryption Information | 6.2.2.12 | O/R | Y | |
| IS-95 Channel Identity | 6.2.2.10 | O/C | Y | |
| Mobile Identity | 6.2.2.16 | O/R | Y | ESN and |
| | | | | IMSI |
| Downlink Radio Environment | 6.2.2.25 | O/C | Y | |
| Service Option | 6.2.2.66 | O/C | Y | |
| CDMA Serving One Way Delay | 6.2.2.79 | O/C | N | |
| IS-95 MS Measured Channel | 6.2.2.36 | O/C | N | |
| Identity | | | | |
| IS-2000 Channel Identity | 6.2.2.34 | O/C | Y | |
| Quality of Service Parameters | 6.2.2.54 | O/C | N | |
| IS-2000 Mobile Capabilities | 6.2.2.70 | O/C | N | |
| IS-2000 Service Configuration | 6.2.2.68 | O/C | N | |
| Record | | | | |
| PDSN IP Address | 6.2.2.30 | O/C | Y | |
| Protocol Type | 6.2.2.71 | O/C | N | |
| Source RNC to Target RNC | 6.2.2.190 | O/C | N | |
| Transparent Container | | | | |
| Slot Cycle Index | 6.2.2.17 | O/C | N | |
| Access Network Identifiers | 6.2.2.189 | O/C | Y | |
| Service Option List | 6.2.2.193 | O/C | N | |
| IS-2000 Channel Identity 3X | 6.2.2.27 | O/C | N | |

Additional details are provide below for the MAP_Prepare_Handover message, which may be sent from the source MSC to target MSC to indicate that for a given MS that already has a dedicated radio resource assigned, a handoff is required.

| MAP_Prepare_Handover | | | | |
|---|---|---|---|---|
| IE | Type | 1xGSM | Handoff Required IE | Comments |
| Invoke Id | M | Y | Message Type | |
| Target Cell Id | C | Y | Cell Identifier List | |
| | | | (Target) | |
| Target RNC Id | C | Y | Access Network | For pkt data call |
| | | | Identifiers | only |
| HO- | C | Y | | |
| NumberNotRequired | | | | |
| IMSI | C | Y | Mobile Identity | |
| Integrity Protection | C | N | | |
| Information | | | | |
| Encryption Information | C | Y | Encryption Information | |
| Radio Resource | C | Y | Downlink Radio | |
| Information | | | Environment | |
| AN-APDU | C | N | | |
| Handover Number | | N | | |
| Relocation Number List | | N | | |
| Multicall Bearer | | N | | |
| Information | | | | |
| Multiple Bearer | C | N | | |
| Requested | | | | |
| Multiple Bearer Not | | N | | |
| Supported | | | | |
| User error | | Y | Cause | For error conditions |
| Provider error | | Y | Cause | For error conditions |
| Extension Parameter | | | | |
| ESN | C | Y | Mobile Identity | Only for CDMA to |
| | | | | CDMA handoff |

Details regarding a BSMAP handoff request message are given below. As previously explained, the handoff request message may be sent from the BS to the MSC to indicate that for a given MS which already has a dedicated radio resource assigned, a handoff is required for the reason given by the cause element.

| Handoff Request IE | Section | Type | 1xGSM | Comments |
|---|---|---|---|---|
| Message Type | 6.2.2.4 | M | Y | |
| Channel Type | 6.2.2.7 | M | Y | MTC_{T} shall provide this info |
| Encryption | 6.2.2.12 | M | Y | MTC_{T} obtain over MAP message |
| Information | | | | |
| Classmark Information | 6.2.2.15 | M | Y | MTC_{T} shall populate this IE with |
| Type 2 | | | | default values. |
| Cell Identifier List | 6.2.2.21 | M | Y | MTC_{T} obtain over MAP message |
| (Target) | | | | |
| Circuit Identity Code | 6.2.2.23 | O/C | Y | Provided by MTC_{T} the circuit |
| Extension | | | | type for voice, data or Fax |
| | | | | service |
| IS-95 Channel Identity | 6.2.2.10 | O/C | Y | Since MAP message do not carry |
| | | | | this information, therefore, the |
| | | | | MTC_{T} shall provide required |
| | | | | values for this parameter. |
| | | | | Following values shall be used; |
| | | | | Hard Handoff = 1 |
| | | | | Number of channels = 001 |
| Mobile Identity (IMSI) | 6.2.2.16 | O/R | Y | MTC_{T} obtain over MAP message |
| Mobile Identity (ESN) | 6.2.2.16 | O/R | Y | Required for CDMA to CDMA |
| | | | | handoffs for the target BS can |
| | | | | calculate the Public Long Code |
| | | | | Mask. This is an extension to the |
| | | | | MAP message to enable 1xGSM |
| | | | | handoff in CDMA domain. |
| Downlink Radio | 6.2.2.25 | O/R | Y | Required for DS-41 to MC-41 |
| Environment | | | | handoff |
| Service Option | 6.2.2.66 | O/C | Y | This element indicates the |
| | | | | service option requested by the |
| | | | | MS, or by the network. |
| CDMA Serving One | 6.2.2.79 | O/R | N | |
| Way Delay | | | | |
| IS-95 MS Measured | 6.2.2.36 | O/C | N | |
| Channel Identity | | | | |
| IS-2000 Channel | 6.2.2.34 | O/C | Y | Since MAP message do not carry |
| Identity | | | | this information, therefore, the |
| | | | | MTC_{T} obtain shall provide |
| | | | | required values for this |
| | | | | parameter. Following values |
| | | | | shall be used; |
| | | | | Physical channel count = 1 |
| Quality of Service | 6.2.2.54 | O/C | N | Only for pkt data call |
| Parameters | | | | |
| IS-2000 Mobile | 6.2.2.70 | O/C | N | |
| Capabilities | | | | |
| IS-2000 Service | 6.2.2.68 | O/C | N | |
| Configuration Record | | | | |
| PDSN IP Address | 6.2.2.30 | O/C | Y | Only for pkt data call |
| Protocol | | | | |
| Protocol Type | 6.2.2.71 | O/C | N | Only for pkt data call |
| Type Source RNC to | 6.2.2.190 | O/C | N | UMTS related |
| Target RNC | | | | |
| Transparent Container | | | | |
| Slot Cycle Index | 6.2.2.17 | O/C | N | MTC_{T} shall assume non-slotted |
| | | | | mode of operation |
| Access Network | 6.2.2.189 | O/C | Y | Only for pkt data call |
| Identifiers | | | | |
| Service Option List | 6.2.2.193 | O/C | N | Not present if the Service Option |
| | | | | element is present. |
| IS-2000 Channel | 6.2.2.27 | O/C | N | Only for CDMA 3x to 3x system |
| Identity 3X | | | | HHO |

The above disclosure provides many different embodiments, or examples, for implementing the invention. However, specific examples, and processes are described to help clarify the invention. These are, of course, merely examples and are not intended to limit the invention from that described in the claims. For instance, even though the MAP protocol may have been described as the GSM protocol to exchange handoff information between the two hybrid switches, the present invention can apply to any GSM protocol in the Core network that can achieve the same functionality. Additionally, although a general switching system is used to describe the HMSC, the present disclosure contemplates that any switching system providing similar function can substitute the HMSC. Such switching system may include one or more network entities with centralized call control, or even a different call control system, and is capable of serving one or more RANs of same or different technologies, and linking the RANs to a CN of a predetermined wireless technology. For instance, a soft switch technology can be used to implement the HMSC which is composed of two parts each implemented in an independent network entity. The first part will handle control part of a call and the other network entity will handle the bearer part. When using soft switch technology as the HMSC, a maximum leverage of equipment investment is reached since the network configuration becomes highly scalable.

Additionally, although a dual-mode mobile that can support voice and packet data is used to describe the invention, the present disclosure applies to any mobile phone.

The method and system as described above thus provides an economical method and system for providing a handoff solution to a mobile moving between two hybrid networks by using Core network technology protocols, and having both hybrid networks composed of CDMA RAN and GSM CN. In addition, the present disclosure provides a cost effective solution since it does not introduce any change to existing architectures in the RAN and CN for both the GSM and CDMA networks. This may be a significant advantage for a network operator or service provider given that there is no need for investing in upgrading existing equipment, and the migration of the services to be supported by the new network can be achieved in much shorter time and at a lower cost. For example, a CDMA network operator only need to deploy a CDMA RAN that is connected to a HMSC which operates with an existing GSM CN. Therefore, no CDMA based CN deployment may be required.

Also, the present invention presents a solution to deploy a new radio technology into wireless networks without introducing change to the core network. This creates an advantage for network operators that are looking to expand their wireless service coverage of a new radio technology. The present disclosure introduces a low cost and fast deployment time considering that the core network does not have to be substantially changed. By deploying a new radio technology over an existing core network of an existing technology, major advantages are achieved at the radio access network such as higher bit rates which leads to faster data download. Other advantages are higher network capacity and increase in spectrum efficiency on the radio frequency involved which leads to the ability of supporting larger number of subscribers and introducing better quality of service to the mobile users.

Furthermore, while the invention has been particularly shown and described with reference to the preferred embodiment thereof, it will be understood by those skilled in the art that various changes in form and detail may be made therein without departing from the spirit and scope of the invention, as set forth in the following claims.

1. A method for performing mobile handoff between a first and second hybrid networks, each hybrid network having a core network and an access network based on a first technology and a second technology respectively, the method comprising:
servicing a call session of a mobile device in the first hybrid network;
detecting the mobile device moving from the first hybrid network to the second hybrid network;
using a hybrid mobile switch center compatible with both the first and second technologies and a predetermined protocol to handle message communications based on different technologies for the mobile handoff; and
continuing the call session in the second hybrid network.

2. The method of claim 1 wherein the first technology is CDMA and the second technology is selected from the group consisting of GSM and TDMA.

3. The method of claim 1 wherein the first technology is GSM and the second technology is selected from the group consisting of CDMA and TDMA.

4. The method of claim 1 wherein the first technology is TDMA and the second technology is selected from the group consisting of CDMA and GSM.

5. A method for performing mobile handoff between a first and second hybrid networks, each hybrid network having a core network and an access network based on a first technology and a second technology respectively, the method comprising:
receiving an indication to prepare for handoff from a source MSC in accordance with the first technology;
sending a handoff request message to a target base station system in accordance with the second technology;
receiving a indication that the target base station system is ready in accordance with the second technology;
sending a message to the source MSC to indicate a successful completion of the handoff preparation in accordance with the first technology; and
setting up a traffic channel with the target MSC to allow a handoff to proceed from a source BSC to a target BSC in accordance with the first technology.

6. The method of claim 5 wherein the first technology is CDMA and the second technology is selected from the group consisting of GSM and TDMA.

7. The method of claim 5 wherein the first technology is GSM and the second technology is selected from the group consisting of CDMA and TDMA.

8. The method of claim 5 wherein the first technology is TDMA and the second technology is selected from the group consisting of CDMA and GSM.

9. The method of claim 5 wherein the indication to prepare for handoff is a MAP prepare handover message.

10. The method of claim 5 wherein the handoff request message is an Handoff Request message.

11. The method of claim 5 wherein the indication that the target base is ready is a handoff acknowledgement message.

12. The method of claim 5 wherein the message to the source to indicate a successful completion is a MAP Prepare Handover message.

13. The method of claim 5 wherein the setting up a traffic channel further comprises:
receiving an initial address message; and
sending an address complete message.

14. A method for performing mobile handoff between a first and second hybrid networks, each hybrid network having a core network and an access network based on a first technology and a second technology, the method comprising:
receiving an indication that a handoff is required from a source BSC in accordance with the first technology;
sending a handoff preparation message to a target MSC in accordance with the second technology;
receiving a response to the handoff preparation message in accordance with the second technology;
setting up a traffic channel with the target MSC to allow a handoff to proceed from a source BSC to a target BSC in accordance with the first technology.

15. The method of claim 14 further comprising:
sending a handoff command in accordance with a second technology to the source BSC;
receiving a response in accordance with a second technology from the source BSC so that a handoff can be commenced between the source BSC and the target BSC.

16. The method of claim 14 wherein the first technology is CDMA and the second technology is selected from the group consisting of GSM and TDMA.

17. The method of claim 14 wherein the first technology is GSM and the second technology is selected from the group consisting of CDMA and TDMA.

18. The method of claim 14 wherein the first technology is TDMA and the second technology is selected from the group consisting of CDMA and GSM.

19. The method of claim 14 wherein the indication that a handoff is required is a hard handoff required message.

20. The method of claim 14 wherein the handoff preparation message is a MAP prepare handover message.

21. The method of claim 14 wherein the response to the handoff preparation message is a MAP Prepare Handover Response message.

22. The method of claim 14 wherein the setting up a traffic channel further comprises:
sending an initial address message; and
receiving an address complete message.

23. A telecommunications system having at least first and second hybrid networks and at least one hybrid mobile switching center, the system comprising:
the first hybrid network having a core network and an access network based on a first technology and a second technology, respectively;
the second hybrid network having a core network and an access network based on the first technology and the second technology, respectively;
a hybrid mobile switching center compatible with both the first and second technologies and associated with a predetermined protocol to handle message communications based on different technologies for a mobile handoff; and
instructions for performing the mobile handoff between the first and second hybrid networks, the instructions comprising:
instructions for detecting a mobile device moving from the first hybrid network to the second hybrid network; and
instructions for using the hybrid mobile switch center to mediate between the first and second hybrid networks and the first and second technologies to accomplish the mobile handoff.

24. The telecommunications system of claim 23 wherein the hybrid mobile switching center is the only interface between the first and second technologies.

25. The telecommunications system of claim 23 wherein the first technology is CDMA and the second technology is selected from the group consisting of GSM and TDMA.

26. The telecommunications system of claim 23 wherein the first technology is GSM and the second technology is selected from the group consisting of CDMA and TDMA.

27. The telecommunications system of claim 23 wherein the first technology is TDMA and the second technology is selected from the group consisting of CDMA and GSM.
